(19) United States
(12) Patent Application Publication
(10) Pub. No.: US 2004/0207864 A1
(43) Pub. Date: Oct. 21, 2004

(54) Method for operating a printer and method for operating a printer controller

(76) Inventors: Steven Donald Combs, Lexington, KY (US); Tung-Fu Hsieh, Jubei (TW); Brian Keith Owens, Lexington, KY (US); Bruce Barton Vance, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/419,021

(22) Filed: Apr. 18, 2003

(51) Int. Cl. G06F 3/12; G06F 15/00; G06F 9/44

(52) U.S. Cl. 358/1.13; 358/406; 710/8; 717/168

(57) ABSTRACT

One method operates a printer-controller application specific integrated circuit (ASIC) by applying a predetermined voltage to an analog input pin which identifies a desired operating mode (such as, but not limited to, one of at least several test modes) of the ASIC. An analog-to-digital converter (ADC) converts the voltage to a digital output which is used to configure the ASIC to operate in the desired operating mode. Another method operates a printer by applying a predetermined voltage to an analog input pin of an ADC which identifies the printer (such as, without limitation, the particular make or the particular make and model of the printer). The digital output of the ADC is used to configure a printer-controller ASIC to operate with the identified printer (such as, but not limited to, setting the maintenance cycle timing and/or setting the default printing mode required by the identified printer).

### TECHNICAL FIELD

The present invention relates generally to printing, and more particularly to a method for operating a printer and to a method for operating a printer controller.

### BACKGROUND OF THE INVENTION

Printers include, without limitation, computer printers, copiers, and facsimile machines. Some conventional printers, such as some inkjet printers, include a printer-controller application specific integrated circuit (ASIC). The printer-controller ASIC includes firmware which is programmed by the printer manufacturer and which is not intended to be changed by the user. The printer-controller ASIC controls operation of the printer under the command of the firmware. The printer manufacturer uses different firmware programs for different brands of printers.

A conventional printer-controller ASIC has one normal mode and typically has at least several test modes. Each test mode tests a particular portion or portions of the printer-controller ASIC. Some conventional inkjet printers use a printer-controller ASIC having several digital input pins and apply different combinations of high and low signals on these pins to select the normal mode or one of the test modes in which to operate the printer-controller ASIC. ASIC testing may be accomplished by a built-in-self-test (BIST) program or may be accomplished by an external ASIC tester with the digital input pin signal being used by the ASIC to configure the ASIC input/output for a particular test.

Many printer-controller ASICs have firmware and an embedded analog-to-digital converter (ADC). The ADC has an analog input pin and has a digital output operatively connected to the firmware. By “operatively connected” is meant that the digital output is connected to a digital section of the ASIC which is under firmware control.

What is needed is an improved method for operating a printer and/or an improved method for operating a printer controller.

### SUMMARY OF THE INVENTION

A first method of the invention is for operating a printer-controller application specific integrated circuit (ASIC) including an analog-to-digital converter (ADC) having an analog input pin. The first method includes steps a) through d). Step a) includes applying a predetermined voltage to the analog input pin wherein the predetermined voltage provides identification of a desired operating mode of the printer-controller ASIC. Step b) includes converting the predetermined voltage to a digital output using the ADC. Step c) includes using the digital output to configure the printer-controller ASIC to operate in the desired operating mode. Step d) includes operating the configured printer-controller ASIC.

A second method of the invention is for operating a printer-controller application specific integrated circuit (ASIC) having firmware and having an embedded analog-to-digital converter (ADC), wherein the ADC has an analog input pin and has a digital output operatively connected to the firmware. The second method includes steps a) and b). Step a) includes programming the firmware to configure the printer-controller ASIC to operate in any one of a plurality of operating modes depending upon the value of the digital output of the ADC. Step b) includes applying a predetermined voltage to the analog input pin wherein the predetermined voltage provides identification of a desired operating mode of the printer-controller ASIC.

A third method of the invention is for operating a printer having a printer-controller application specific integrated circuit (ASIC) including an analog-to-digital converter (ADC) having an analog input pin. The third method includes steps a) through d). Step a) includes applying a predetermined voltage to the analog input pin, wherein the predetermined voltage provides identification of the printer. Step b) includes converting the predetermined voltage to a digital output using the ADC. Step c) includes using the digital output to configure the printer-controller ASIC to operate with the identified printer. Step d) includes operating the printer with the configured printer-controller ASIC.

A fourth method of the invention is for operating a printer having a printer-controller application specific integrated circuit (ASIC) including firmware and including an embedded analog-to-digital converter (ADC), wherein the ADC has a digital output operatively connected to the firmware and has an analog input pin. The fourth method includes steps a) through c). Step a) includes programming the firmware to configure the printer-controller ASIC to operate with any one of a plurality of printers depending upon the value of the digital output of the ADC. Step b) includes applying a predetermined voltage to the analog input pin wherein the predetermined voltage provides identification of the printer having the printer-controller ASIC. Step c) includes operating the identified printer with the configured printer-controller ASIC.

Several benefits and advantages are derived from one or more of the methods of the invention. Choosing one of many test modes of a printer-controller ASIC by applying a predetermined voltage to the analog input pin of an ADC embedded in the printer-controller ASIC reduces the pin count of the ASIC. This pin count reduction is compared to conventional ASICs requiring several or more digital input pins on which is applied a combination of high and low signals. Reducing the number of pins reduces the cost and size of the ASIC. Programming printer-controller ASIC firmware to configure the ASIC to operate with different printers depending upon the value of the digital output of an ADC embedded in the ASIC allows the same firmware program of the ASIC to be used for different printers. A particular make or particular make and model printer is identified by a predetermined voltage applied to the analog input pin of the ASIC. In one example, the predetermined voltage is created by supplying the particular printer with a particular resistor to change a standard printer power supply voltage to the particular predetermined voltage which identifies the particular printer make or particular printer make and model.

### BRIEF DESCRIPTION OF THE DRAWINGS

FIG. 1 is a flow chart of a first method for operating a printer-controller ASIC;

FIG. 2 is a flow chart of a second method for operating a printer-controller ASIC;

FIG. 3 is a flow chart of a third method for operating a printer; and

FIG. 4 is a flow chart of a fourth method for operating a printer.

### DETAILED DESCRIPTION

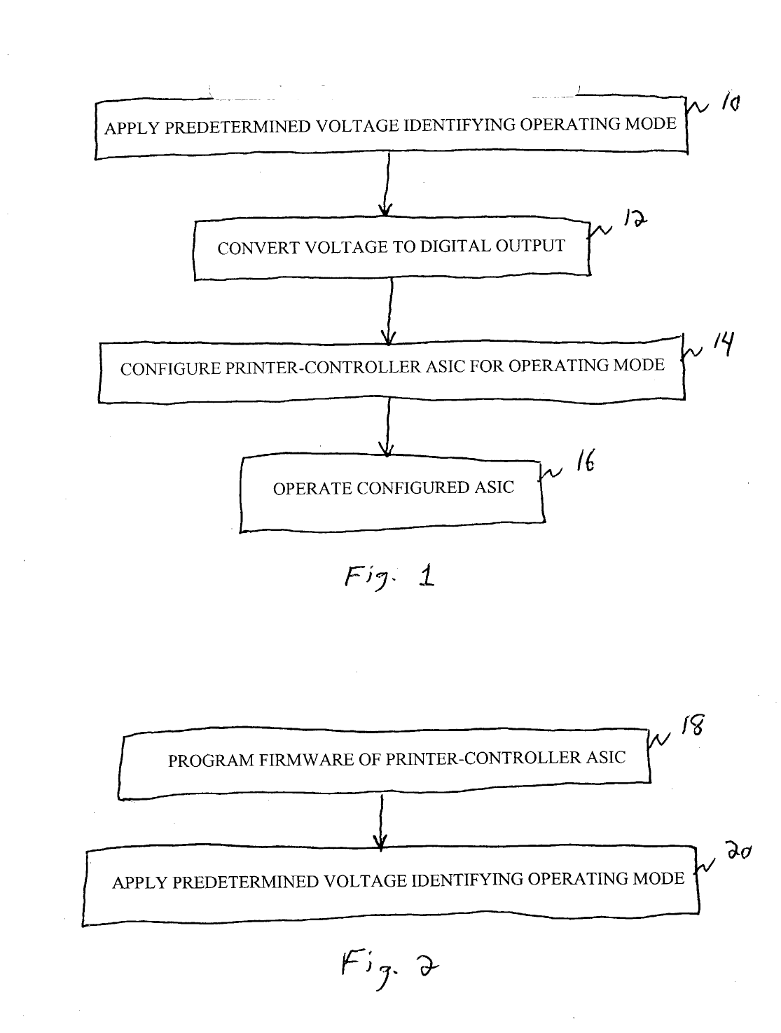

Referring to FIG. 1, a first method of the invention is for operating a printer-controller application specific integrated circuit (ASIC). The printer-controller ASIC includes an analog-to-digital converter (ADC). The ADC has an analog input pin. The first method includes steps a) through d). Step a) is labeled as “Apply Predetermined Voltage Identifying Operating Mode” in block 10 of FIG. 1. Step a) includes applying a predetermined voltage to the analog input pin wherein the predetermined voltage provides identification of a desired operating mode of the printer-controller ASIC. Step b) is labeled as “Convert Voltage To Digital Output” in block 12 of FIG. 1. Step b) includes converting the predetermined voltage to a digital output using the ADC. Step c) is labeled as “Configure Printer-Controller ASIC For Operating Mode” in block 14 of FIG. 1. Step c) includes using the digital output to configure the printer-controller ASIC to operate in the desired operating mode. Step d) is labeled as “Operate Configured ASIC” in block 16 of FIG. 1. Step d) includes operating the configured printer-controller ASIC.

It is noted that a printer-controller controls operation of a printer such as, without limitation, controlling the firing of inkjet nozzles of a printhead of an inkjet printer, controlling the movement of the inkjet printhead carrier across the paper, and controlling the inkjet paper feed roller to advance the paper. Other types of print media, other types of control operations, and other types of printers which employ, or can employ, a printer controller are left to the artisan. It also is noted that the term “printer” includes, without limitation, computer printers, copiers, and facsimile machines. In one construction, the ADC is embedded in the printer-controller ASIC. In another construction, the ADC is not embedded in the printer-controller ASIC but is considered to be a part of the ASIC for purposes of describing the methods of the invention. In one embodiment, step b) is performed by ASIC hardware rather than running under software or firmware control since the ASIC will be in an unknown state until after the operating mode is selected.

In one example of the first method, the desired operating mode is a test mode of the printer-controller ASIC. In one variation, the desired operating mode is one of a plurality of test modes of the printer-controller ASIC. In one modification, a predetermined voltage of say 3.1 volts would cause the printer-controller ASIC to run test number 1, a predetermined voltage of say 3.2 volts would cause the printer-controller ASIC to run test number 2, a predetermined voltage of say 3.3 volts would cause the printer-controller ASIC to run test number 3, etc.

In one embodiment, the digital output of the ADC is used by the ASIC to configure ASIC input and output for the desired operating mode when the operating mode is a test mode and when an external ASIC test provides the required test vectors. In another embodiment, the digital output of the ADC is used by the ASIC to configure the ASIC to start operating at the address of the register which begins the built-in-self-test (BIST) programming for the desired operating mode when the operating mode is a BIST test mode.

In another example of the first method, the desired operating mode is a normal mode of the printer-controller ASIC. A normal mode is a non-test mode and is the normal operating mode of the corresponding printer having the printer-controller ASIC installed therein. In one illustration, in the normal mode, a user may choose to print a page in a draft print mode or in a higher quality print mode wherein the printer-controller ASIC controls the printer to print the page in the chosen print mode.

In one variation of the above example of the first method, the desired operating mode is one of a multiplicity of normal modes for a corresponding multiplicity of different printers. In one illustration, normal mode number 1 indicates to the printer-controller ASIC that it is installed in a brand X printer, normal mode number 2 indicates to the printer-controller ASIC that it is installed in a brand Y printer, etc., wherein different brand printers require differently configured ASICs. In one enablement, a brand X printer requires that the printer-controller ASIC be configured to command a 2.0 microsecond inkjet nozzle firing time and a brand Y printer requires that the printer-controller ASIC be configured to command a 2.1 microsecond inkjet nozzle firing time. In one modification, a brand X printer has a different make and/or is a different model than a brand Y printer. In one construction, a predetermined voltage of say 2.7 volts indicates a brand X printer and a predetermined voltage of say 2.8 volts indicates a brand Y printer. Other illustrations, enablements, modifications, constructions, and types of printers are left to the artisan.

In an additional example of the first method, the desired operating mode is one chosen from the group consisting of a plurality of test modes of the printer-controller ASIC and a multiplicity of normal modes for a corresponding multiplicity of different printers. In this example, a single input pin of the printer-controller ASIC (which is the analog input pin of the ADC when the ADC is embedded in the ASIC) is used to individually select any one of a plurality of test modes for execution by the printer-controller ASIC. In this example, the same single input pin also is used to configure the printer-controller ASIC to run in any one of a multiplicity of normal modes wherein the chosen normal mode is the normal mode for the particular printer in which the printer-controller ASIC is installed.

Referring to FIG. 2, a second method of the invention is for operating a printer-controller application specific integrated circuit (ASIC). The printer-controller ASIC has firmware and has an embedded analog-to-digital converter (ADC). The ADC has an analog input pin and has a digital output operatively connected to the firmware. By “operatively connected” is meant that the digital output is connected to a digital section of the ASIC which is under firmware control. The method includes steps a) and b). Step a) is labeled as “Program Firmware Of Printer-Controller ASIC” in block 18 of FIG. 2. Step a) includes programming the firmware to configure the printer-controller ASIC to operate in any one of a plurality of operating modes depending upon the value of the digital output of the ADC. As is understood by the artisan, firmware is programmed by the printer manufacturer and is not intended to be changed by the user. Programming firmware to accomplish step a) is within the routine capabilities of those skilled in the art. Step b) is labeled as “Apply Predetermined Voltage Identifying Operating Mode” in block 20 of FIG. 2. Step b) includes applying a predetermined voltage to the analog input pin wherein the predetermined voltage provides identification of a desired operating mode of the printer-controller ASIC.

In one example of the second method, the desired operating mode is a test mode of the printer-controller ASIC. In another example, the desired operating mode is a normal mode of a printer. In an additional example, the desired operating mode is chosen from the group consisting of a plurality of test modes of the printer-controller ASIC and a multiplicity of normal modes for a corresponding multiplicity of different printers.

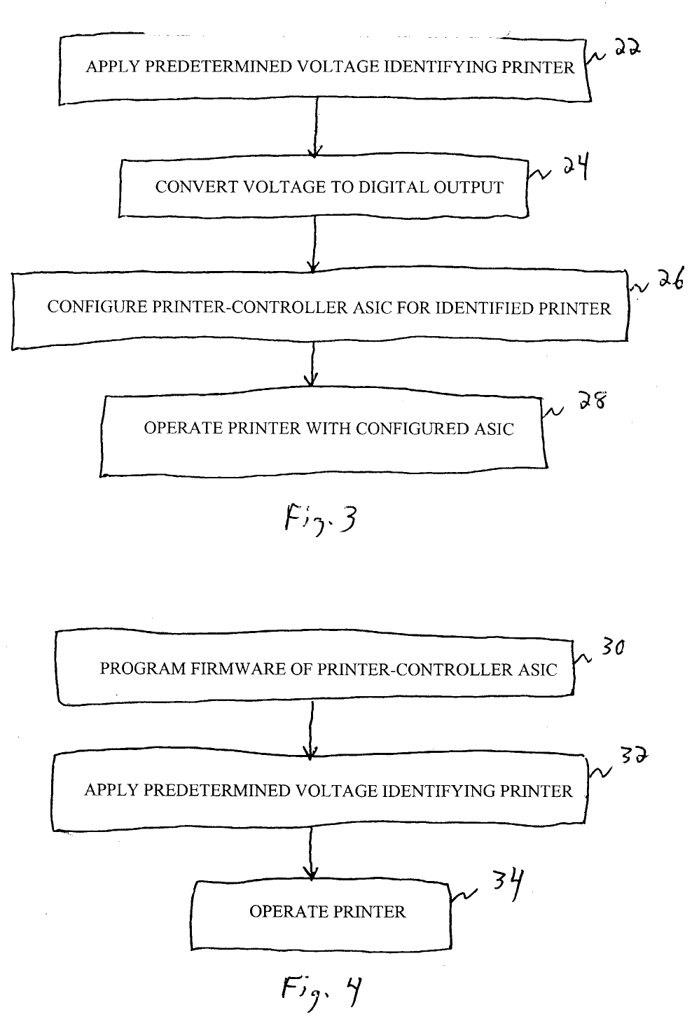

Referring to FIG. 3, a third method of the invention is for operating a printer having a printer-controller application specific integrated circuit (ASIC). The printer-controller ASIC includes an analog-to-digital converter (ADC). The ADC has an analog input pin. The third method includes steps a) through d). Step a) is labeled as “Apply Predetermined Voltage Identifying Printer” in block 22 of FIG. 3. Step a) includes applying a predetermined voltage to the analog input pin, wherein the predetermined voltage provides identification of the printer. Step b) is labeled as “Convert Voltage To Digital Output” in block 24 of FIG. 2. Step b) includes converting the predetermined voltage to a digital output using the ADC. Step c) is labeled as “Configure Printer-Controller ASIC For Identified Printer” in block 26 of FIG. 3. Step c) includes using the digital output to configure the printer-controller ASIC to operate with the identified printer. Step d) is labeled as “Operate Printer With Configured ASIC” in block 28 of FIG. 3. Step d) includes operating the printer with the configured printer-controller ASIC.

In one example of the third method, the predetermined voltage provides identification of the make of the printer. In one variation of this example, the predetermined voltage also provides identification of the model of the printer.

In one illustration of the third method, the digital signal is used to configure the printer-controller ASIC to provide the correct maintenance cycle timing for the identified printer. In the same or a different illustration, the digital signal is used to configure the printer-controller ASIC to provide the correct default printing mode for the identified printer. For example, one brand of printer may require a draft printing mode of one print pass of the printhead across the paper before advancing the paper while another brand of printer may require a higher quality printing mode of two print passes of the printhead across the paper before advancing the paper, as can be appreciated by the artisan. In one variation, the same digital signal, in identifying the particular printer in which the printer-controller ASIC is installed, is used to configure numerous aspects of the printer-controller ASIC to the requirements of the particular printer. Other illustrations of other configured aspects of the printer-controller ASIC include, without limitation, setting the correct printhead firing time for the identified printer and providing or not providing for bi-directional printing.

Referring to FIG. 4, a fourth method of the invention is for operating a printer having a printer-controller application specific integrated circuit (ASIC). The printer-controller ASIC includes firmware and includes an embedded analog-to-digital converter (ADC). The ADC has an analog input pin and has a digital output operatively connected to the firmware. The fourth method includes steps a) through c). Step a) is labeled as “Program Firmware Of Printer-Controller ASIC” in block 30 of FIG. 4. Step a) includes programming the firmware to configure the printer-controller ASIC to operate with any one of a plurality of printers depending upon the value of the digital output of the ADC. Programming firmware to accomplish step a) is within the routine capabilities of those skilled in the art. Step b) is labeled as “Apply Predetermined Voltage Identifying Printer” in block 32 of FIG. 4. Step b) includes applying a predetermined voltage to the analog input pin wherein the predetermined voltage provides identification of the printer having the printer-controller ASIC. Step c) is labeled as “Operate Printer” in block 34 of FIG. 4. Step c) includes operating the identified printer with the configured printer-controller ASIC.

In one example of the fourth method, the predetermined voltage provides identification of the make of the printer. In one variation of this example, the predetermined voltage also provides identification of the model of the printer.

In one illustration of the fourth method, the digital signal is used to configure the printer-controller ASIC to provide the correct maintenance cycle timing for the identified printer. In the same or a different illustration, the digital signal is used to configure the printer-controller ASIC to provide the correct default printing mode for the identified printer. In one embodiment, the digital signal is used by the ASIC to modify particular registers and/or particular sets of data in the ASIC to meet the requirements of the identified printer.

It is noted that any of the optional examples, variations, etc. of any one of the first through fourth methods can be used in one or more of the other of the first through fourth methods. In one embodiment of the methods, a separate boot pin is included to boot the printer-controller ASIC.

Several benefits and advantages are derived from one or more of the methods of the invention. Choosing one of many test modes of a printer-controller ASIC by applying a predetermined voltage to the analog input pin of an ADC embedded in the printer-controller ASIC reduces the pin count of the ASIC. This pin count reduction is compared to conventional ASICs requiring several or more digital input pins on which is applied a combination of high and low signals. Reducing the number of pins reduces the cost and size of the ASIC. Programming printer-controller ASIC firmware to configure the ASIC to operate with different printers depending upon the value of the digital output of an ADC embedded in the ASIC allows the same firmware program of the ASIC to be used for different printers. A particular make or particular make and model printer is identified by a predetermined voltage applied to the analog input pin of the ASIC. In one example, the predetermined voltage is created by supplying the particular printer with a particular resistor to change a standard printer power supply voltage to the particular predetermined voltage which identifies the particular printer make or particular printer make and model.

The foregoing description of several methods of the invention has been presented for purposes of illustration. It is not intended to be exhaustive or to limit the invention to the precise procedures disclosed, and obviously many modifications and variations are possible in light of the above teaching. It is intended that the scope of the invention be defined by the claims appended hereto.

What is claimed is:

1. A method for operating a printer-controller application specific integrated circuit (ASIC) including an analog-to-digital converter (ADC) having an analog input pin comprising the steps of:
a) applying a predetermined voltage to the analog input pin wherein the predetermined voltage provides identification of a desired operating mode of the printer-controller ASIC;
b) converting the predetermined voltage to a digital output using the ADC;
c) using the digital output to configure the printer-controller ASIC to operate in the desired operating mode; and
d) operating the configured printer-controller ASIC.

2. The method of claim 1, wherein the desired operating mode is a test mode of the printer-controller ASIC.

3. The method of claim 1, wherein the desired operating mode is one of a plurality of test modes of the printer-controller ASIC.

4. The method of claim 1, wherein the desired operating mode is a normal mode of a printer.

5. The method of claim 1, wherein the desired operating mode is one of a multiplicity of normal modes for a corresponding multiplicity of different printers.

6. The method of claim 1, wherein the desired operating mode is one chosen from the group consisting of a plurality of test modes of the printer-controller ASIC and a multiplicity of normal modes for a corresponding multiplicity of different printers.

7. A method for operating a printer-controller application specific integrated circuit (ASIC) having firmware and having an embedded analog-to-digital converter (ADC), wherein the ADC has an analog input pin and has a digital output operatively connected to the firmware, and wherein the method comprises the steps of:
a) programming the firmware to configure the printer-controller ASIC to operate in any one of a plurality of operating modes depending upon the value of the digital output of the ADC; and
b) applying a predetermined voltage to the analog input pin wherein the predetermined voltage provides identification of a desired operating mode of the printer-controller ASIC.

8. The method of claim 7, wherein the desired operating mode is a test mode of the printer-controller ASIC.

9. The method of claim 7, wherein the desired operating mode is a normal mode of a printer.

10. The method of claim 7, wherein the desired operating mode is chosen from the group consisting of a plurality of test modes of the printer-controller ASIC and a multiplicity of normal modes for a corresponding multiplicity of different printers.

11. A method for operating a printer having a printer-controller application specific integrated circuit (ASIC) including an analog-to-digital converter (ADC) having an analog input pin comprising the steps of:
a) applying a predetermined voltage to the analog input pin, wherein the predetermined voltage provides identification of the printer;
b) converting the predetermined voltage to a digital output using the ADC;
c) using the digital output to configure the printer-controller ASIC to operate with the identified printer; and
d) operating the printer with the configured printer-controller ASIC.

12. The method of claim 11, wherein the predetermined voltage provides identification of the make of the printer.

13. The method of claim 12, wherein the predetermined voltage provides identification of the model of the printer.

14. The method of claim 11, wherein the digital signal is used to configure the printer-controller ASIC to provide the correct maintenance cycle timing for the identified printer.

15. The method of claim 11, wherein the digital signal is used to configure the printer-controller ASIC to provide the correct default printing mode for the identified printer.

16. A method for operating a printer having a printer-controller application specific integrated circuit (ASIC) including firmware and including an embedded analog-to-digital converter (ADC), wherein the ADC has an analog input pin and has a digital output operatively connected to the firmware, and wherein the method comprises the steps of:
a) programming the firmware to configure the printer-controller ASIC to operate with any one of a plurality of printers depending upon the value of the digital output of the ADC;
b) applying a predetermined voltage to the analog input pin wherein the predetermined voltage provides identification of the printer having the printer-controller ASIC; and
c) operating the identified printer with the configured printer-controller ASIC.

17. The method of claim 16, wherein the predetermined voltage provides identification of the make of the printer.

18. The method of claim 17, wherein the predetermined voltage provides identification of the model of the printer.

19. The method of claim 16, wherein the digital signal is used to configure the printer-controller ASIC to provide the correct maintenance cycle timing for the identified printer.

20. The method of claim 16, wherein the digital signal is used to configure the printer-controller ASIC to provide the correct default printing mode for the identified printer.
